(19) United States
(12) Patent Application Publication
(10) Pub. No.: US 2026/0080261 A1
(43) Pub. Date: Mar. 19, 2026

(54) DATASET CREATION FOR LARGE LANGUAGE MODEL FINETUNING

(71) Applicant: Schlumberger Technology Corporation, Sugar Land, TX (US)

(72) Inventors: Omkar Anil Gune, Pune (IN); Rushikesh Khilare, Pune (IN)

(21) Appl. No.: 19/301,403

(22) Filed: Aug. 15, 2025

(30) Foreign Application Priority Data
Sep. 13, 2024 (IN) 202411069441

(51) Int. Cl. G06N 3/096; G06N 3/042

(52) U.S. Cl. CPC G06N 3/096; G06N 3/042

(57) ABSTRACT

A general large language model (LLM) processes a prompt on a current region including a set of chunks of a domain specific source document to generate a question for the current region and an answer for the question. The current region is expanded by incorporating adjacent chunks to the set of chunks. The general LLM processes the question and the current region to revise the answer and identify a set of second answer chunks in the current region used to revise the answer. The operations include generating a question vector embedding for the question and performing retrieval augmentation matching with the question vector embedding and chunk vector embeddings of the chunks. The general LLM processes the question and the current region to revise the answer and identify a set of third answer chunks used to revise the answer. The domain specific LLM is updated with the question and answer.

### CROSS REFERENCE TO RELATED APPLICATIONS

This application claims benefit to India Application Serial No. 202411069441, filed on Sep. 13, 2024, and incorporated herein by reference.

### BACKGROUND

Large Language Models (LLMs) are generally trained models that are trained to perform a variety of tasks. Each of the variety of tasks may be performed for a multitude of different users and a multitude of different domains. Because of the size of the LLM, the training dataset to train the LLM is massive. Thus, LLMs are generally trained models.

One type of task that is common for an LLM is to receive and process a question and generate an answer. Specifically, LLMs perform well in understanding natural language and producing natural language outputs. However, a defect of LLMs, especially general LLMs, is that general LLMs have the tendency to output hallucinations. Hallucinations are outputs that are coherent and grammatically correct while being technically incorrect or even absurd.

To address this challenge, previous systems have performed retrieval augmentation generation (RAG), whereby during an initial phase of question processing, a RAG framework gathers multiple documents that the RAG framework detects as relevant to the end user's question, and then sends the documents to the general LLM with the end user's question. The RAG framework reduces the likelihood of the general LLM from performing hallucinations. However, because a general LLM is used, the general LLM may still produce hallucinations.

A goal is to create a domain specific LLM that has a lower likelihood of hallucinations when presented with questions for a particular domain. With the amount of training data that is needed to train the LLM to be domain specific, and the fact that the amount of training data is generally not available, a challenge exists in training an LLM to be domain specific. Any answer to a question in the domain specific training dataset should be complete, precise, and accurate.

### SUMMARY

Dataset creation for large language model (LLM) finetuning includes performing operations. A general large language model (LLM) processes a prompt on a current region including a set of chunks in the chunks of a domain specific source document to generate a question for the current region and an answer for the question. The operations include expanding the current region to update the current region by incorporating adjacent chunks in the set of chunks to the chunk in the current region. The general LLM processes the question and the current region to revise the answer for the question and identify a set of second answer chunks in the current region used to revise the answer. The operations include generating a question vector embedding for the question and performing retrieval augmentation matching with the question vector embedding and chunk vector embeddings of the chunks. The retrieval augmentation matching updates the current region by augmenting the current region with at least one additional chunk of the chunks. The general LLM processes the question and the current region to revise the answer for the question and identify a set of third answer chunks in the current region used to revise the answer. The domain specific LLM is updated with the question and the answer after revising the answer after performing the retrieval augmentation matching.

Other aspects of one or more embodiments will be apparent from the following description and the appended claims.

### BRIEF DESCRIPTION OF DRAWINGS

FIG. 1 shows a diagram of a system in accordance with one or more embodiments.

FIG. 2 shows a flowchart in accordance with one or more embodiments.

FIG. 3 shows an example in accordance with one or more embodiments.

FIG. 4.1 and FIG. 4.2 show a computing system in accordance with one or more embodiments.

Like elements in the various figures are denoted by like reference numerals for consistency.

### DETAILED DESCRIPTION

A large language model (LLM) is a type of artificial intelligence (AI) program that can recognize and generate text, among other tasks. LLMs are trained on huge sets of data and may have billions of parameters that may be adjusted. LLMs are trained to process questions and generate answers. A question may also be referred to as a prompt and may include one or more statements. Any form of a question may be used. The answer is the output of the LLM.

LLMs are often generally trained to recognize and generate text, and then may be finetuned for a particular domain. Finetuning an LLM uses a large question and answer (QA) dataset where answers are accurate and complete. The answers should match the questions. Obtaining a QA dataset with complete and accurate answers is a time-consuming process.

One or more embodiments generate high quality and complete answers in a QA dataset used for LLM finetuning in an automated fashion without manual intervention. The LLM is then trained with the QA dataset. The development and finetuning of LLMs is performed to address complex, domain specific challenges across industries. An example domain is the oil and gas domain, where technical precision and context are important.

The workflow for generating a complete and reliable dataset of questions and answers for finetuning LLMs on domain specific data involves multiple steps designed to ensure both completeness, precision, and accuracy of the answers. Generating the answer is through multiple iterations so that the answer is a complete and accurate answer to the question.

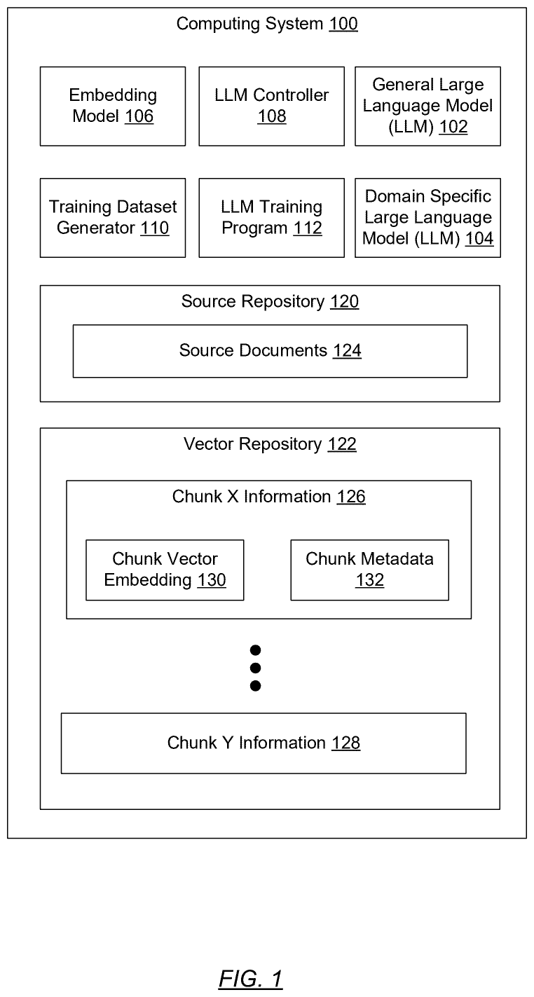

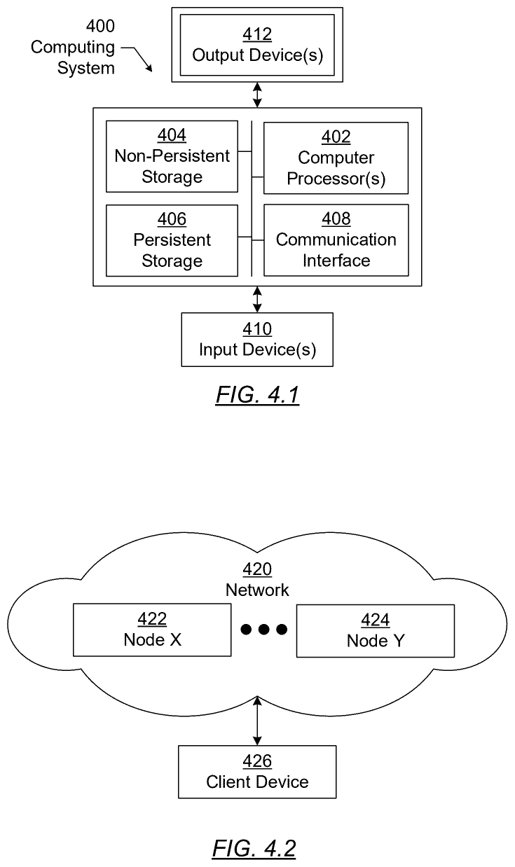

FIG. 1 shows a diagram of a system. As shown in FIG. 1, the system is a computing system (100). For example, the computing system (100) may be the computing system described in FIG. 4.1 and 4.2. The system may include a source repository (120), a vector repository (122), one or more LLMs (e.g., a general LLM (102), a domain specific LLM (104)) as described above, an embedding model (106), a LLM controller (108), a training dataset generator (110), and an LLM training program (112). The LLM controller is software configured to perform finetuning of the domain specific LLM (104). The QA generator is configured to generate QA pairs for training the LLM as described in the present application. Each of these components are described below.

The source repository (120) includes a set of source documents (124). A document or source document is broadly defined to include any record or file that has data specific to the particular domain. For example, the domain specific documents may be reports, instruction manuals, academic papers, a collection of records, invoices, seismic surveys, lab reports, and other types of documents. The source documents may be variable in terms of document length, type, complexity, etc.

Moreover, hundreds or thousands of source documents may exist. Each source document is specific to a domain. A domain is an area of expertise. In particular, a domain is a specific area of activity or knowledge. For example, a domain may be an industry or subindustry of a company having the domain specific LLM (104).

The vector repository (122) stores chunk information (e.g., chunk X information (126), chunk Y information (128)). The chunk information maintains information about a corresponding chunk. A chunk is a contiguous portion of a source document. For example, a chunk may be a contiguous set of text. As another example, the chunk may be a figure and corresponding textual description of the figure. Preprocessing on the chunk may be performed, such as to remove stop words or normalize terms in the document.

The chunk information for a chunk includes a chunk vector embedding (130) and chunk metadata (132). The chunk vector embedding (130) is a numerical encoding of the corresponding chunk. Specifically, the chunk vector embedding (130) encodes the subject matter in the text or images within the chunk. The chunk information (e.g., chunk X information (126)) includes chunk metadata (132). The chunk metadata (132) is information about the chunk. For example, the chunk metadata (132) may include a document identifier, a location identifier of the chunk (e.g., a page or section of the document in which the chunk is located), a unique identifier of the chunk, a stop and end extent of the chunk, and other information about the chunk. For example, the chunk identifier may be a consecutive identifier of the chunk.

Continuing with FIG. 1, the one or more LLMs (e.g., a general LLM (102), a domain specific LLM (104)) corresponds to the standard definition used in the art. The LLM is as described above. A general LLM (102) is an LLM that is generally trained across a variety of domains and a variety of topics. A domain specific LLM (104) is an LLM that is finetuned or trained for a particular domain. Specifically, a domain specific LLM is trained using embodiments described herein. The domain specific LLM is configured to answer user questions having a topic within a particular domain. The domain specific LLM is trained to accurately, precisely, and completely answer the user questions.

The embedding model (106) is configured to generate a chunk vector embedding (130) for the chunk. The embedding model is the type of machine learning model that transforms the chunk into a lower dimensional vector space. In one or more embodiments, the embedding model (106) is a transformer model. As another example, the embedding model may be the encoder layers of a long, short term memory (LSTM) model. Other types of embedding models may be used without departing from the scope of the claims.

The LLM controller (108) is configured to interface with the general LLM (102). For example, the LLM controller (108) is configured to generate a prompt for the general LLM (102) and then transmit the prompt with the question to the LLM. The LLM controller (108) is further configured to receive an answer to the prompt from the LLM. The LLM controller (108) may further be configured to add additional instructions to the prompt and transform the answer, such as changing the format of the answer.

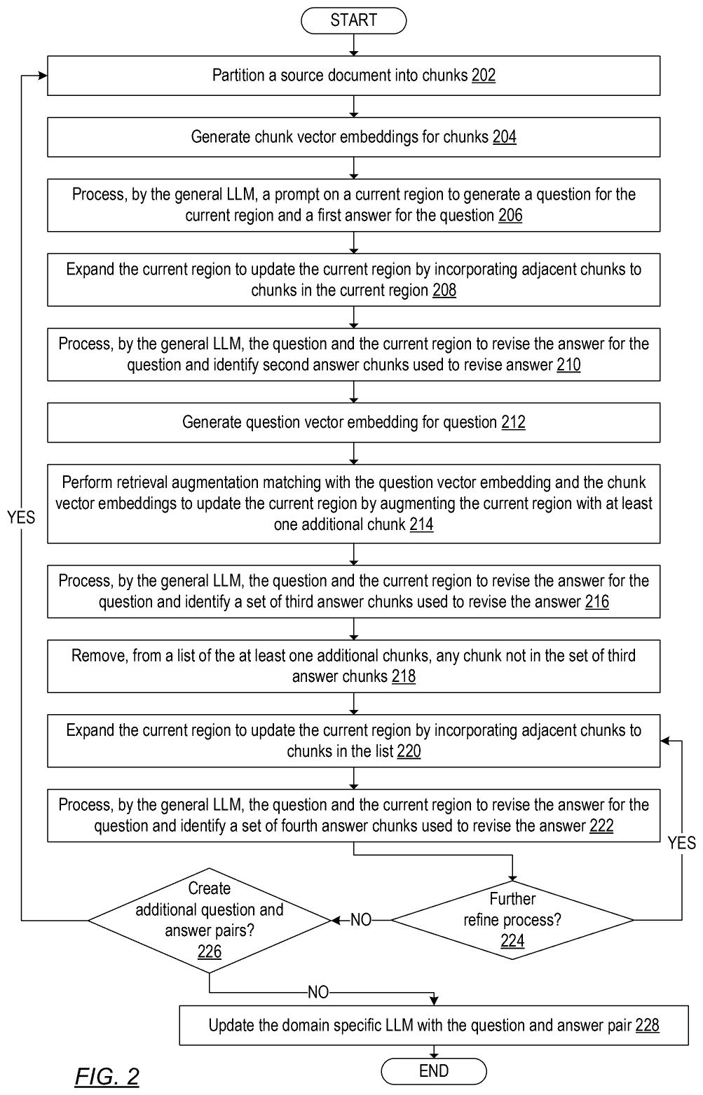

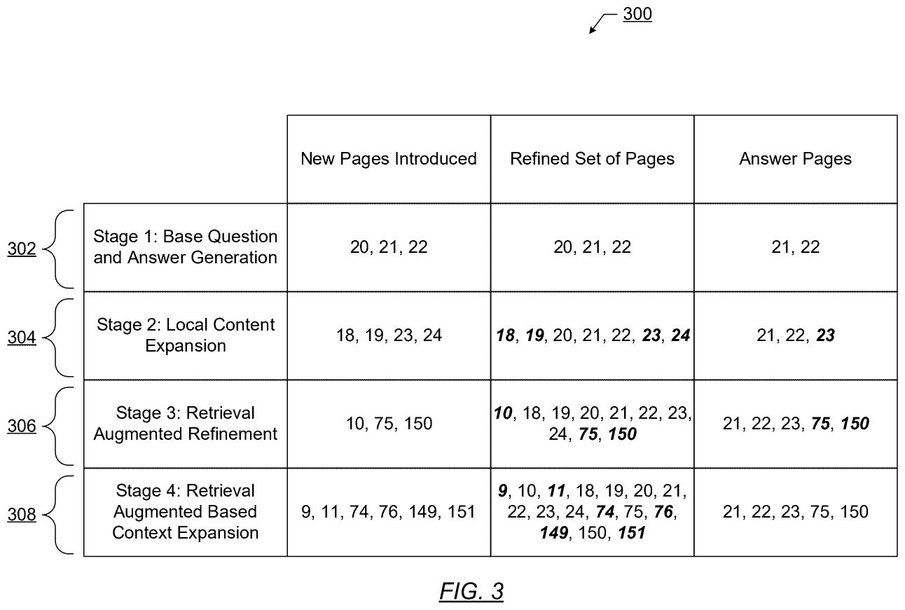

The training dataset generator (110) is configured to generate a training dataset that is domain specific from the source documents (124). Specifically, the training dataset generator (110) is configured to generate a question and answer using the general LLM (102) and then iteratively refine the answer. The operations of the training dataset generator are described in FIG. 2 and FIG. 3 below.

The LLM training program (112) is configured to train the domain specific LLM. The LLM training program (112) is configured to generate a loss using a loss function. For example, the loss function may be a cross entropy loss that uses the number of correct answers to the number of incorrect answers. The loss may be a per token loss, whereby a token is an individual term in the predicted answer and generated answer in the training dataset. For example, a statistic regarding the tokens that are correct may form a first portion of the loss whereas a statistic about incorrect tokens may form a second portion of the loss.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart in accordance with one or more embodiments. The flowchart of FIG. 2 may be implemented using the system of FIG. 1 and one or more of the steps may be performed on or received at one or more computer processors. While the various steps in this flowchart are presented and described sequentially, at least some of the steps may be executed in different orders, may be combined or omitted, and at least some of the steps may be executed in parallel. Furthermore, the steps may be performed actively or passively.

The flow starts with data extraction and preprocessing. The system may include several domain specific source documents. A source document is selected from the domain specific source documents. Block 202 includes partitioning a source document into chunks. A chunk is a consecutive set of terms in the document. In being a consecutive set, stop words and other such words may be removed. The size of the text chunk may be dependent on the LLM. Each text chunk is associated with a chunk and other metadata from the document.

Partitioning the source document into chunks may be based on the sections of the document. For example, the sections may be individual pages, subtopics of the document as defined by a corresponding structure, a chapter or subchapter of the document, an individual report in the case that the document includes multiple reports, etc. To partition the document into chunks, the chunks may correspond to a section or a portion of the section of the document. For example, the chunk may correspond to an individual paragraph, figure, or other portion. The training dataset generator parses the document to identify the sections and selects a chunk size. Based on the chunk size, the training dataset generator may combine multiple sections into a single chunk if the chunk size is a multiple of the section size. The training dataset generator may set each section as its own chunk if the chunk size is greater than or equal to the section size, but not a multiple of the section size. The training dataset generator may partition a section into chunks if the chunk size is smaller than the section. Each chunk may be assigned a chunk identifier that is consecutive. The chunk identifier may be associated with the chunk in the chunk metadata of the chunk information.

Block 204 includes generating chunk vector embeddings for the chunks. Each chunk is individually passed through the embedding model. For example, the embedding model may be an LSTM or other transformer model that processes the chunks and generates a vector embedding for the chunk. The vector embedding encodes one or more topics for the chunk. The vector embedding is stored in the vector repository with metadata describing the chunk. For example, the metadata may be a unique identifier of the chunk, a location of the chunk with respect to other chunks in the document, an identifier of the document as a whole, or other information.

For a predefined number of tokens, consecutive text chunks are selected from the entire document. For example, a text chunk of two thousand tokens could be selected as a context for creating a question and answer. Text chunk is also associated with the metadata of chunk numbers from where the text is derived.

Block 206 includes processing, by the general LLM, a prompt on a current region to generate a question for the current region and a first answer for the question. Block 206 involves generating one or more base-level question-answer (QA) pairs. A set of chunks having one or more chunks is selected from the set of chunks obtained in Block 202 in the source document. Once the set of chunks is obtained, a prompt template is populated with the set of chunks or with a reference to the set of chunks. Thus, initially, the current region in the document is just the chunk. The prompt template includes a request to the general LLM to generate a question from the chunk. The prompt template also requests that the general LLM generate an answer to the question from the chunk. In some embodiments, separate prompts are generated, whereby a first prompt requests the question for the chunk and the second prompt requests the answer for the chunk. The prompt requesting the answer also includes a format of the answer and a request that the LLM response includes the answer and identifies the answer chunks. The answer chunks are the chunks used in generating the answer. Specifically, the answer chunks are the one or more chunks in which the answer may be found. Initially, the answer chunk is the single chunk from which the answer is generated. However, as explained below, with subsequent refining, the answer chunk may be multiple chunks.

The general LLM processes the prompt(s) through the transformer layers of the general LLM model. Specifically, the general LLM encodes the prompt and the chunk into vector embeddings, and then processes the vector embeddings by applying weights and activation functions to the vector embeddings. Through the iterative processing, the general LLM generates a response that includes a question and an answer. Notably, because the general LLM generates the answer and the answer is only based on the chunk from which the question is obtained, the answer may be inaccurate or incomplete. Thus, the additional processing refines the answer to generate the training data. The answer may reference the specific chunk, such as the chunk identifier.

Block 208 includes expanding the current region to update the current region by incorporating adjacent chunks to chunks in the current region. The adjacent chunks may be the neighboring chunks. Further, the neighboring chunks may include multiple consecutive chunks in each direction. Block 208 performs context expansion for answer enhancement. In the initial stages (e.g., such as a 2,000 token chunk), the generated question and answer (QA) pairs may lack sufficient context to fully represent the answer. To address this lack of sufficient context, the context of each QA pair is expanded locally by appending additional chunks from the same document, both preceding and following the original chunk. By increasing the scope of context to include neighboring chunks, the QA pairs are reprocessed to verify whether there are any contradictions or any extra information present in the new context that refines or enhances the accuracy of the answers in the previous step.

Block 210 includes processing, by the general LLM, the question and the current region to revise the answer for the question and identify a set of second answer chunks used to revise the answer. The set of second answer chunks may be one or more of the chunks in the current region. The processing in Block 210 may be performed in a same or similar manner to Block 206. In Block 210, the current region is the expanded region generated in Block 208. Thus, by including more context through the expanded region, the general LLM may provide a more complete, precise, or accurate answer that includes information from the neighboring chunks. The general LLM may be prompted with the previous answer and requested to revise the previous answer or the general LLM may be prompted with the question and through processing create a new answer that is a revision of the previous answer. Further, the general LLM identifies the second answer chunks, such as the answer chunks that are used to generate the answer. The second answer chunks may be all or a subset of the answer chunks, depending on the chunks relied upon to generate the answer.

Block 212 includes generating a question vector embedding for the question. The embedding model that generates the chunk vector embedding generates a question vector embedding using the question generated in Block 206.

Block 214 includes performing retrieval augmentation matching with the question vector embedding and the chunk vector embeddings to update the current region by augmenting the current region with at least one additional chunk. Block 214 may involve performing refinement using the RAG framework. The question vector embedding is compared to the chunk vector embeddings to identify matching chunk embeddings. The matching chunk embeddings may be matched based on being within a threshold distance (e.g., threshold co-sine distance) or based on probability matching through a neural network. The additional chunks may be the same document or a different document. For example, the question in each QA pair is re-evaluated within the RAG workflow of the RAG framework, retrieving relevant chunks from the vector database from the various parts of the documents. Specifically, the chunk identifiers in the chunk metadata associated with the matching chunk embedding are used to identify the newly matched chunk. The one or more additional chunks are added to the current region. Notably, the current region may or may not be a contiguous region of the document and may be in multiple documents.

Block 216 includes processing, by the general LLM, the question and the current region to revise the answer for the question and identify a set of third answer chunks in the current region that are used to revise the answer. The set of second answer chunks may be one or more of the chunks in the current region. The processing in Block 216 may be performed using the same or similar technique discussed above with reference to Block 206. The general LLM may be prompted with the previous answer and requested to revise the previous answer or the general LLM may be prompted with the question and through processing create a new answer that is a revision of the previous answer. The current region processed in Block 216 is the current region after Block 214 while the question is the same as in Block 206. The result is an answer and identifiers of the answer chunks (i.e., third answer chunks) that are used to generate the answer in Block 216.

Block 218 includes removing from a list of the at least one additional chunks, any chunk that is not in the set of third answer chunks. A list of the at least one additional chunk added in Block 214 is generated. The training dataset generator compares the third answer chunks to a list. Any chunk in the list that is not in the third answer chunks is removed from the list. The result is an updated list.

Block 220 includes expanding the current region to update the current region by incorporating adjacent chunks to chunks in the list. Block 220 involves expanding the current region to include adjacent chunks to the additional chunks that are in the list. Including the adjacent chunks may be performed similar to Block 208. Block 220 includes ensuring a dense and comprehensive ground truth involves a local expansion iteration similar to the context expansion process. For chunks identified through RAG retrieval, the chunk's local context is further expanded by appending neighboring chunks. For example, the chunk's local context may be performed by expanding two chunks before and after the identified chunk. The chunks are integrated into the current region.

Block 222 includes processing, by the general LLM, the question and the current region to revise the answer for the question and identify a set of fourth answer chunks used to revise the answer. Block 222 is performed in a similar manner to Block 216 described above. Because the additional context is provided, the answer (i.e., third answer) is a further refined version of the previous answers (i.e., second answer, first answer, and initial answer). If the chunk identifiers of the set of fourth answer chunks are the same as the set of third answer chunks, then the revised answer after Block 222 and Block 216 may be the same because the answer is derived from the same locations in the one or more documents.

Block 224 includes determining whether to further refine the answer. The process described above may be repeated by adding additional chunks from retriever until the context of answer (e.g., chunks from where answer is derived) becomes stabilized. Determining whether to further refine the process may be based on whether a stop criterion is reached. The stop criterion may be when the answer chunks enter a steady state. For example, the set of fourth answer chunks may be compared to the set of third answer chunks to determine whether the answer changed. Specifically, a determination is made whether the answers match. The answers are assumed to match if the answer chunks are the same. As another example, the matching of the answer chunks may be performed using a small language model or natural language techniques (e.g., keywords, term frequency-inverse document frequency (TF-IDF), etc.). If the answer chunks enter a steady state, then the general LLM is likely to not further refine the answer with additional information. As another example, the stop criterion may be the number of iterations of refining the answer.

One or more embodiments include a dataset quality assessment. The quality of answers generated for questions are monitored. High quality answers and corresponding questions can be used to finetune the LLM. Based on the variations in pages from where the answer is derived at different stages of the workflow, quality of dataset can be assessed.

If the determination is made to continue, the processing continues with Block 220, whereby the current region is expanded by adding additional adjacent chunks to the chunks in the fourth answer chunks. Then, in Block 222, the general LLM the question again interfaces with the general LLM and the current region.

Block 226 includes determining whether to create additional question and answer pairs. The determination as to whether to create additional questions and answers may be based on whether the current questions and answers are diverse. Questions could be diverse in terms of their answers as short answers, long answers, answers spanning multiple pages, factual answers.

If the determination is made to create additional question and answer pairs, then the flow returns to Block 202.

Continue with FIG. 2, in Block 228, the domain specific LLM is updated with the question and answer pair(s). Updating may include training or evaluating the domain specific LLM. Specifically, using the generated QA dataset, the LLM is finetuned. Finetuning involves, for each of the multiple QA pairs of the generated dataset, submitting the question to the LLM and receiving a response from the LLM. The response is compared to the corresponding answer to generate a loss. A separate model may be used to calculate the loss. As another example, a trained LLM may calculate a loss difference between the correct answer and the response. The loss is backpropagated through the LLM to generate an updated LLM model. Further, a subset of the question and answer pairs may be used to evaluate the domain specific LLM. Evaluation includes the domain specific LLM processing the questions to generate a predicted answer, and then comparing the predicted answer to the answer in the pair to determine the accuracy of the domain specific LLM. In some embodiments, similar to training or evaluating the document specific LLM, the domain specific LLM RAG operations may be trained or evaluated. The training and evaluation may be performed to determine whether the RAG operations are acquiring correct data to feed to the domain specific LLM to answer the question. Accordingly, the result of finetuning the LLM using embodiments described herein is a better trained domain specific LLM resulting in the computing system creating more accurate and complete answers.

In some embodiments, embodiments cluster the question and answer pairs according to types. The types may include targeted questions, multi-page question, multi hop questions, etc. The clustering may be performed based on the request in the prompt or using natural language or other clustering techniques. By clustering the question and answer pairs, different training and evaluation may be performed. For example, the domain specific LLM may trained for a particular complexity level, or the evaluation may determine the accuracy based on the types of pairs and to generate output partitioned according to type. which can help in understanding evaluation of LLM based systems. Moreover, having dataset with different types of questions based on complexity labels may be useful in deciding training strategy for domain LLM in a curriculum learning framework.

Although FIG. 2 is presented as a single document being partitioned and analyzed, FIG. 2 and the claims are not limited to the chunks being from a single document. Rather, multiple documents may be partitioned into the various chunks. Thus, the set of answer chunks may include chunks from multiple documents in FIG. 2.

FIG. 3 shows an example showing an iterative refinement process to generate domain specific training data for training a specific LLM. The following example is for explanatory purposes only and not intended to limit the scope of one or more embodiments. The iterative refinement process is shown as a chart (300) for explanatory purposes only. In the iterative refinement process, new pages are added to context for answer refinement.

In Stage 1 (302), the base question and answer generation is performed. As shown in the chart, pages 20, 21, and 22 are randomly selected. Because this is the first iteration, the refined set of pages are 20, 21, and 22. The general LLM processes a prompt asking for a question related to the topic that can be answered by pages 20, 21, and 22. The general LLM also answers the question that the general LLM created. As shown in the first row of the chart and the answer pages column, the general LLM responds with the answer and that the answer is found on pages 20 and 21. Therefore, although three pages were provided to the general LLM, the answer is generated from only two.

In Stage 2 (304), local context expansion is performed. In the local context expansion, adjacent pages are added. Thus, in the example, pages, 20, 21, and 22 are expanded by two pages in both directions thereby introducing pages 18, 19, 23, and 24. The general LLM processes a new prompt to generate an answer for pages 18 through 24 (i.e., the refined set of pages). The general LLM responds with an answer as well as the answer pages. At least a portion of the answer is found on page 23. Thus, the answer pages are pages 21, 22, and 23.

In Stage 3 (306), retrieval augmented refinement is performed. The question is sent to the retrieval augmentation generation (RAG) system to generate a vector embedding of the question. The vector embedding is compared to vector embeddings in the vector repository to identify additional matching pages. The pages may appear random and not necessarily very close to the pages that were originally selected. As shown on the third row in the example, pages 10, 75, and 150. The pages are added to the refined set of pages. Thus, the refined set of pages include pages 10, 18, through 24, 75, and 150. The refined set of pages are sent with the question to the general LLM to obtain an answer and the answer pages where the answer may be found. When the answer is derived from the refined set of pages, the pages that include the answer are refined to be pages 21, 22, 23, 75, and 150.

In Stage 4 (308), retrieval augmented based context expansion is performed. In the retrieval augmented based context expansion, additional pages are added based on being adjacent to the pages that were added based on the vector embedding. In the example, pages 9, 11, 74, 76, 149, and 151 are added based on being adjacent to pages 10, 75, and 150. Thus, the refined set of pages to send to the general LLM is 9, 10, 11, 18, 19, 20, 21, 22, 23, 24, 74, 75, 76, 149, 150, and 151. The LLM processes the refined set of pages to generate an answer and the pages in which the answer is found. The pages in which the answer is found includes pages 21, 22, 23, 75, and 150. Because the pages in which the answer is found matches the pages in which the answer was previously found (i.e., in Stage 3 (306)), the system may stop iterations. If the pages were not to match, then further spatial expansion is performed with Stage 3 to add additional adjacent pages.

Once the answer pages enter a steady state of matching prior answer pages, the training dataset generator determines that the answer has been completely refined. Thus, further refinement of the answer is determined to not be possible based on additional context. Accordingly, the test dataset is augmented by adding the question generated by the general LLM as well as the answer generated by the general LLM after the Stage 4 refinement.

The processing set forth in the above example is performed with several different pages of the document to obtain various domain specific question and answer pairs for the particular document. The processing may be further repeated for hundreds or thousands of domain specific source documents. By performing the operations over the pages of the many source documents, a domain specific training dataset is generated.

After generating the training dataset, the specific LLM is trained. Training the specific LLM involves processing, by the specific LLM, the input that includes a question and context. The context is generated by a RAG framework that processes the question to identify various documents or portions of documents relevant to the question. The context is generated separate of generating the question and answer as described above. The specific LLM applied converts the question and context into one or more vector representations and applies one or more layers of weights to the vector representation(s). For each layer of the LLM, the weights of the layer may be multiplied by the input vector to generate a collection of products, which may then be summed to generate an output for the layer that may be fed, as input data, to a next layer within the LLM. The output of the LLM may be the output generated from the last layer within the LLM that is transformed to the predicted answer. The predicted answer is compared to the training answer in the question and answer pair to identify the difference. Over the course of several question and answer pairs, the differences are accumulated to form a loss as defined by a loss function to identify updates to the weights of the layers of the model. After training on a batch of inputs, the updates identified by the loss function may be applied to the machine learning model to generate a trained machine learning model. Different algorithms may be used to calculate and apply the updates to the specific LLM, including back propagation, gradient descent, etc.

The result of the processing in the example is a specific LLM that is a general LLM further trained on domain specific data. Because the iterative process is performed, the automatically generated answer is determined to be complete and accurate. By generating training data, a specific LLM is able to be trained for a particular domain. Through the iterative process of generating the answer, the generated training answer is accurate causing the specific LLM to be more accurate through the specific LLM training process.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 4.1, the computing system (400) may include one or more computer processor(s) (402), non-persistent storage device(s) (404), persistent storage device(s) (406), a communication interface (408) (e.g., Bluetooth interface, infrared interface, network interface, optical interface, etc.), and numerous other elements and functionalities that implement the features and elements of the disclosure. The computer processor(s) (402) may be an integrated circuit for processing instructions. The computer processor(s) (402) may be one or more cores, or micro-cores, of a processor. The computer processor(s) (402) includes one or more processors. The computer processor(s) (402) may include a central processing unit (CPU), a graphics processing unit (GPU), a tensor processing unit (TPU), combinations thereof, etc.

The input device(s) (410) may include a touchscreen, keyboard, mouse, microphone, touchpad, electronic pen, or any other type of input device. The input device(s) (410) may receive inputs from a user that are responsive to data and messages presented by the output device(s) (412). The inputs may include text input, audio input, video input, etc., which may be processed and transmitted by the computing system (400) in accordance with one or more embodiments. The communication interface (408) may include an integrated circuit for connecting the computing system (400) to a network (not shown) (e.g., a local area network (LAN), a wide area network (WAN) such as the Internet, mobile network, or any other type of network) or to another device, such as another computing device, and combinations thereof.

Further, the output device(s) (412) may include a display device, a printer, external storage, or any other output device. One or more of the output device(s) (412) may be the same or different from the input device(s) (410). The input device(s) (410) and output device(s) (412) may be locally or remotely connected to the computer processor(s) (402). Many different types of computing systems exist, and the aforementioned input device(s) (410) and output device(s) (412) may take other forms. The output device(s) (412) may display data and messages that are transmitted and received by the computing system (400). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (402), is configured to perform one or more embodiments, which may include transmitting, receiving, presenting, and displaying data and messages described in the other figures of the disclosure.

The computing system (400) in FIG. 4.1 may be connected to, or be a part of, a network. For example, as shown in FIG. 4.2, the network (420) may include multiple nodes (e.g., node X (422) and node Y (424), as well as extant intervening nodes between node X (422) and node Y (424)). Each node may correspond to a computing system, such as the computing system shown in FIG. 4.1, or a group of nodes combined may correspond to the computing system shown in FIG. 4.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (400) may be located at a remote location and connected to the other elements over a network.

The nodes (e.g., node X (422) and node Y (424)) in the network (420) may be configured to provide services for a client device (426). The services may include receiving requests and transmitting responses to the client device (426). For example, the nodes may be part of a cloud computing system. The client device (426) may be a computing system, such as the computing system shown in FIG. 4.1. Further, the client device (426) may include or perform all or a portion of one or more embodiments.

The computing system of FIG. 4.1 may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology.

Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
processing, by a general large language model (LLM), a prompt on a current region comprising a set of chunks in a plurality of chunks of a domain specific source document to generate a question for the current region and an answer for the question;
expanding the current region to update the current region by incorporating adjacent chunks in the plurality of chunks to the set of chunks in the current region;
processing, by the general LLM, the question and the current region to revise the answer for the question and identify a set of second answer chunks in the current region used to revise the answer;
generating a question vector embedding for the question;
performing retrieval augmentation matching with the question vector embedding and a plurality of chunk vector embeddings of the plurality of chunks, wherein the retrieval augmentation matching updates the current region by augmenting the current region with at least one additional chunk of the plurality of chunks;
processing, by the general LLM, the question and the current region to revise the answer for the question and identify a set of third answer chunks in the current region used to revise the answer; and
updating a domain specific LLM with the question and the answer after revising the answer after performing the retrieval augmentation matching.

2. The method of claim 1, wherein the plurality of chunk vector embeddings spans a plurality of domain specific source documents comprising the domain specific source document, and wherein after performing the retrieval augmentation matching, the current region incorporates at least two chunks from different domain specific source documents in the plurality of domain specific source documents.

3. The method of claim 1, further comprising:
expanding the current region to update the current region by incorporating a set of adjacent chunks to chunks in a list of the at least one additional chunk; and
processing, by the general LLM, the question and the current region to revise the answer for the question and identify a set of fourth answer chunks used to revise the answer, wherein the training is performing after identifying the set of fourth answer chunks.

4. The method of claim 3, further comprising:
removing from the list of the at least one additional chunks, any chunk that is not in the set of third answer chunks prior to expanding the current region.

5. The method of claim 1, further comprising:
partitioning a source document into the plurality of chunks; and
generating, by an embedding model, the plurality of chunk vector embeddings for the plurality of chunks.

6. The method of claim 1, further comprising:
determining whether to further refine the answer after performing the retrieval augmentation matching, and
iteratively refining the answer with the general LLM.

7. The method of claim 6, wherein determining whether to refine the answer comprises:
matching the set of fourth answer chunks to the set of third answer chunks to determine whether the set of fourth answer chunks are the same as the set of third answer chunks; and
determining to refine the answer in the question and answer pair when the set of fourth answer chunks are the same as the set of third answer chunks do not match.

8. The method of claim 1, further comprising:
creating, through processing a plurality of source documents with the general LLM, a plurality of question and answer pairs comprising the question and answer pair to generate a training dataset; and
training the specific LLM with the training dataset.

9. The method of claim 1, wherein updating the domain specific LLM comprises at least one selected from a group consisting of training the domain specific LLM and evaluating the domain specific LLM.

10. The method of claim 1, wherein updating the domain specific LLM comprises at least one selected from a group consisting of training the domain specific LLM-RAG operations and evaluating a domain specific LLM-RAG operations.

11. The method of claim 1, further comprising:
clustering a plurality of question and answer pairs comprising the question and answer pair according to type,
wherein updating the domain specific LLM uses the type.

12. A system comprising:
at least one computer processor;
a general large language model (LLM) executing on the at least one computer processor and configured to:
processing a prompt on a current region comprising a set of chunks in a plurality of chunks of a domain specific source document to generate a question for the current region and an answer for the question,
processing the question and the current region to revise the answer for the question and identify a set of second answer chunks in the current region used to revise the answer, and
processing the question and the current region to revise the answer for the question and identify a set of third answer chunks in the current region used to revise the answer;
a training dataset generator executing on the at least one computer processor and configured to:
expanding, after generating the question and the answer, the current region to update the current region by incorporating adjacent chunks in the plurality of chunks to the set of chunks in the current region,
generating a question vector embedding for the question, and
performing, after identifying the set of second answer chunks, retrieval augmentation matching with the question vector embedding and a plurality of chunk vector embeddings of the plurality of chunks, wherein the retrieval augmentation matching updates the current region by augmenting the current region with at least one additional chunk of the plurality of chunks; and
an LLM training program executing on the at least one computer processor and configured to:
train a domain specific LLM with the question and the answer after revising the answer after performing the retrieval augmentation matching.

13. The system of claim 12, wherein the plurality of chunk vector embeddings spans a plurality of domain specific source documents comprising the domain specific source document, and wherein after performing the retrieval augmentation matching, the current region incorporates at least two chunks from different domain specific source documents in the plurality of domain specific source documents.

14. The system of claim 12, wherein the training dataset generator is further configured to:
expanding the current region to update the current region by incorporating a set of adjacent chunks to chunks in a list of the at least one additional chunk; and
processing, by the general LLM, the question and the current region to revise the answer for the question and identify a set of fourth answer chunks used to revise the answer, wherein the training is performing after identifying the set of fourth answer chunks.

15. The system of claim 12, wherein the training dataset generator is further configured to:
partitioning a source document into the plurality of chunks; and
generating, by an embedding model, the plurality of chunk vector embeddings for the plurality of chunks.

16. The system of claim 12, wherein the training dataset generator is further configured to:
determining whether to further refine the answer in the question and answer pair after performing the retrieval augmentation matching, and
iteratively refining the answer with the general LLM.

17. The system of claim 12, wherein the training dataset generator is further configured to:
creating, through processing a plurality of source documents with the general LLM, a plurality of question and answer pairs comprising the question and answer pair to generate a training dataset; and
training the specific LLM with the training dataset.

18. A non-transitory computer readable medium comprising computer readable program code for causing a computer system to perform operations comprising:
processing, by the general large language model (LLM), a prompt on a current region comprising a set of chunks in a plurality of chunks of a domain specific source document to generate a question for the current region and an answer for the question;
expanding the current region to update the current region by incorporating adjacent chunks in the plurality of chunks to the set of chunks in the current region;
processing, by the general LLM, the question and the current region to revise the answer for the question and identify a set of second answer chunks in the current region used to revise the answer;
generating a question vector embedding for the question;
performing retrieval augmentation matching with the question vector embedding and a plurality of chunk vector embeddings of the plurality of chunks, wherein the retrieval augmentation matching updates the current region by augmenting the current region with at least one additional chunk of the plurality of chunks;
processing, by the general LLM, the question and the current region to revise the answer for the question and identify a set of third answer chunks in the current region used to revise the answer; and
training a domain specific LLM with the question and the answer after revising the answer after performing the retrieval augmentation matching.

19. The non-transitory computer readable medium of claim 18, wherein the plurality of chunk vector embeddings spans a plurality of domain specific source documents comprising the domain specific source document, and wherein after performing the retrieval augmentation matching, the current region incorporates at least two chunks from different domain specific source documents in the plurality of domain specific source documents.

20. The non-transitory computer readable medium of claim 18, further comprising:
expanding the current region to update the current region by incorporating a set of adjacent chunks to chunks in a list of the at least one additional chunk; and
processing, by the general LLM, the question and the current region to revise the answer for the question and identify a set of fourth answer chunks used to revise the answer, wherein the training is performing after identifying the set of fourth answer chunks.
